(19) United States
(12) Patent Application Publication
(10) Pub. No.: US 2024/0413340 A1
(43) Pub. Date: Dec. 12, 2024

(54) BATTERY

(71) Applicant: Panasonic Intellectual Property Management Co., Ltd., Osaka (JP)

(72) Inventors: Honami SAKO, Osaka (JP); Yoshimasa NAKAMA, Osaka (JP); Akihiko SAGARA, NARA (JP)

(21) Appl. No.: 18/811,280

(22) Filed: Aug. 21, 2024

Related U.S. Application Data
(63) Continuation of application No. PCT/JP2023/005330, filed on Feb. 15, 2023.

(30) Foreign Application Priority Data
Feb. 28, 2022 (JP) 2022-030170

(51) Int. Cl. H01M 4/62; H01M 4/02; H01M 10/0562; H01M 10/42

(52) U.S. Cl. CPC H01M 4/624; H01M 10/0562; H01M 10/4235; H01M 2004/028; H01M 2300/008; H01M 2300/0094

(57) ABSTRACT

A battery of the present disclosure includes a positive electrode, a negative electrode, and an electrolyte layer disposed between the positive electrode and the negative electrode. At least one electrode selected from the group consisting of the positive electrode and the negative electrode includes a solid electrolyte and an ionic liquid containing a lithium salt dissolved. In the electrode including the ionic liquid, a volume proportion of the ionic liquid is less than 20 vol. %. The solid electrolyte includes Li, M, and X, the M is at least one selected from the group consisting of metalloid elements and metal elements except Li, and the X is at least one selected from the group consisting of F, Cl, Br, and I.

This application is a continuation of PCT/JP2023/005330 filed on Feb. 15, 2023, which claims foreign priority of Japanese Patent Application No. 2022-030170 filed on Feb. 28, 2022, the entire contents of both of which are incorporated herein by reference.

### BACKGROUND OF THE INVENTION

### 1. Field of the Invention

The present invention relates to a battery.

### 2. Description of Related Art

WO 2020/170463 A1 discloses an ion-conductive solid electrolyte including an ionic liquid having lithium ion conductivity.

JP 2020-109047 A discloses an all-solid-state battery including a halide solid electrolyte material.

### SUMMARY OF THE INVENTION

The present disclosure aims to provide a battery having a configuration suitable for increasing the discharge voltage and the active material utilization rate.

A battery of the present disclosure includes:
a positive electrode;
a negative electrode; and
an electrolyte layer disposed between the positive electrode and the negative electrode, wherein
at least one electrode selected from the group consisting of the positive electrode and the negative electrode includes a solid electrolyte and an ionic liquid containing a lithium salt dissolved,
in the electrode including the ionic liquid containing the lithium salt dissolved, a volume proportion of the ionic liquid is less than 20 vol. %,
the solid electrolyte includes Li, M, and X,
the M is at least one selected from the group consisting of metalloid elements and metal elements except Li, and
the X is at least one selected from the group consisting of F, Cl, Br, and I.

The present disclosure can provide a battery having a configuration suitable for increasing the discharge voltage and the active material utilization rate.

### BRIEF DESCRIPTION OF THE DRAWINGS

FIG. 1 is a cross-sectional view showing a battery 1000 according to Embodiment 1.

FIG. 2 is a cross-sectional view showing a battery 2000 according to Embodiment 2.

FIG. 3 is a schematic diagram showing a compression molding die 300 used for evaluation of the ionic conductivity of a composite of an ionic liquid containing a lithium salt dissolved and a solid electrolyte.

### DETAILED DESCRIPTION

(Findings on which the Present Disclosure is Based)

WO 2020/170463 A1 described in Description of Related Art discloses enhancing the ion conductivity of an ion conductor (namely, a solid electrolyte) including an ion conductive powder having lithium ion conductivity by adding an ionic liquid containing a lithium salt dissolved to the ion conductor. As for the above solid electrolyte and a battery including the above solid electrolyte, the ion conductive powder is assumed to be an LLZ-based oxide solid electrolyte. Here, LLZ-based oxide solid electrolytes refer to Li₇La₃Zr₂O₁₂ (LLZ) and an element-substituted LLZ. LLZ-based oxide solid electrolytes generally need to undergo a high-temperature firing step to exhibit ion conductivity because having a high resistance due to point contact between the particles. However, according to WO 2020/170463 A1, in an LLZ-based oxide solid electrolyte obtained by adding an ionic liquid containing a lithium salt dissolved and then a binder to an ion conductive powder and shaping the mixture into a sheet, the ionic liquid containing a lithium salt dissolved supplements ion conduction paths, and thus the LLZ-based oxide solid electrolyte obtained by the above method can exhibit lithium ion conductivity without need for high-temperature firing.

According to JP 2020-109047 A, a lithium-ion-conductive solid electrolyte including a halogen element as an anion exhibits high lithium ion conductivity. In the above solid electrolyte and a battery including the above solid electrolyte, the difference between the electronegativities of a cation and an anion included in the solid electrolyte is large; a strong ionic bond between the cation and the anion weakens a lithium-anion interaction, thereby specially increasing the lithium ion conductivity.

As for an all-solid-state battery, an electrode thereof is composed of particulate materials such as a conductive additive, an electrode active material, and a solid electrolyte. Hence, it is difficult to completely eliminate voids even by pressing these particulate materials under high pressure. Moreover, since the electrolyte is a solid, an ion conductor cannot infiltrate secondary particles of the active material. For these reasons, a void that is not used either as an electron conduction path or as an ion conduction path is formed in the electrode. Therefore, even when a solid electrolyte, as disclosed in JP 2020-109047 A, having high lithium ion conductivity is included in an electrode, the electrode resistance increases and a rate of utilization of the active material decreases. The discharge voltage rises consequently.

Therefore, the present inventors conducted intensive studies on constituent materials of an electrode in order to further reduce the battery resistance of a battery including a lithium-ion-conductive solid electrolyte including a halogen element as an anion. As a result, the present inventors found that the active material utilization rate and the discharge voltage are increased by adding an ionic liquid containing a lithium salt dissolved as a constituent material of an electrode. Although details of the mechanism is unclear, it is thought that infiltration of the lithium-ion-conductive ionic liquid into interparticle voids in the electrode and a void in a secondary particle of an active material enhances the ion conductivity of the electrode and increases the discharge voltage and the active material utilization rate.

In light of the above findings, the present inventors have conceived the following battery of the present disclosure.

### Summary of One Aspect According to the Present Disclosure

A battery according to a first aspect of the present disclosure includes:
a positive electrode;
a negative electrode; and
an electrolyte layer disposed between the positive electrode and the negative electrode, wherein
at least one electrode selected from the group consisting of the positive electrode and the negative electrode includes a solid electrolyte and an ionic liquid containing a lithium salt dissolved,
a volume proportion of the ionic liquid in the electrode is less than 20 vol. %,
the solid electrolyte includes Li, M, and X,
the M is at least one selected from the group consisting of metalloid elements and metal elements except Li, and
the X is at least one selected from the group consisting of F, Cl, Br, and I.

The battery according to the first aspect can enhance the ion conductivity (i.e., the effective ion conductivity) of the electrode as a whole. Therefore, the battery according to the first aspect can increase the discharge voltage and the active material utilization rate.

According to a second aspect, for example, in the battery according to the first aspect, the positive electrode may be the electrode including the solid electrolyte and the ionic liquid.

The battery according to the second aspect can enhance the ion conductivity (i.e., the effective ion conductivity) of the positive electrode as a whole. Therefore, the battery according to the second aspect can increase the discharge voltage and the active material utilization rate.

According to a third aspect, for example, in the battery according to the first or second aspect, a lithium ion conductivity at 25° C. may be 1.0×10⁻⁵ S/cm or more in a composite of the ionic liquid and the solid electrolyte.

The battery according to the third aspect can further increase the discharge voltage and the active material utilization rate.

According to a fourth aspect, for example, in the battery according to any one of the first to third aspects, the lithium salt may include at least one selected from the group consisting of lithium tetrafluoroborate (LiBF₄), lithium hexafluorophosphate (LiPF₆), lithium perchlorate (LiClO₄), lithium trifluoromethanesulfonate (CF₃SO₃Li), lithium bis(trifluoromethanesulfonyl)imide (LiN(SO₂CF₃)₂), lithium bis(fluorosulfonyl)imide (LiN(SO₂F)₂), and lithium bis(pentafluoroethanesulfonyl)imide (LiN(SO₂C₂F₅)₂).

The battery according to a fourth aspect can further increase the discharge voltage and the active material utilization rate.

According to a fifth aspect, for example, in the battery according to any one of the first to fourth aspects, the ionic liquid may include: at least one cation selected from the group consisting of an ammonium-based cation, an imidazolium-based cation, a piperidinium-based cation, a pyridinium-based cation, and a pyrrolidinium-based cation; and at least one anion selected from the group consisting of BF₄⁻, N(NC)₂⁻, N(SO₂CF₃)₂⁻, N(FSO₂)₂⁻, CH₃SO₄⁻, CF₃SO₃⁻, and PF₆⁻.

The battery according to the fifth aspect can further increase the discharge voltage and the active material utilization rate.

According to a sixth aspect, for example, in the battery according to any one of the first to fifth aspects, the M may include at least one selected from the group consisting of Mg, Ca, Sr, Y, Sm, Gd, Dy, and Hf.

The battery according to the sixth aspect can further increase the discharge voltage and the active material utilization rate.

According to a seventh aspect, for example, in the battery according to any one of the first to sixth aspects, the X may include at least one selected from the group consisting of Br and I.

The battery according to the seventh aspect can further increase the discharge voltage and the active material utilization rate.

According to an eighth aspect, for example, in the battery according to any one of the first to seventh aspects, the electrolyte layer may include a first electrolyte layer and a second electrolyte layer disposed between the first electrolyte layer and the negative electrode.

The battery according to the eighth aspect can suppress oxidation of a solid electrolyte included in the second electrolyte layer owing to the first electrolyte layer. Therefore, the battery according to the eighth aspect can further enhance the charge and discharge characteristics of the battery.

Embodiments of the present disclosure will be described hereinafter with reference to the drawings.

### Embodiment 1

A battery according to Embodiment 1 of the present disclosure includes a positive electrode, a negative electrode, and an electrolyte layer disposed between the positive electrode and the negative electrode. At least one electrode selected from the group consisting of the positive electrode and the negative electrode includes a solid electrolyte and an ionic liquid containing a lithium salt dissolved. A volume proportion of the ionic liquid in the electrode is less than 20 vol. %. The solid electrolyte includes Li, M, and X. The symbol M is at least one selected from the group consisting of metalloid elements and metal elements except Li, and the symbol X is at least one selected from the group consisting of F, Cl, Br, and I.

In the present specification, the metalloid elements are B, Si, Ge, As, Sb, and Te. The metal elements are all the elements included in Groups 1 to 12 of the periodic table except hydrogen and all the elements included in Groups 13 to 16 of the periodic table except B, Si, Ge, As, Sb, Te, C, N, P, O, S, and Se. That is, the metalloid elements and the metal elements refer to a group of elements that can become cations when forming an inorganic compound with a halogen compound.

In the battery according to Embodiment 1, at least one electrode selected from the group consisting of the positive electrode and the negative electrode includes a solid electrolyte including Li, M, and X, namely, a halide solid electrolyte. As described above, in a lithium-ion-conductive solid electrolyte including a halogen element as an anion, the difference between the electronegativities of the cation and the anion included in the solid electrolyte is large, and thus an ionic bond between the cation and the anion is strong. That weakens a lithium-anion interaction, and thus a high lithium ion conductivity is achieved. Therefore, the battery according to Embodiment 1 includes an electrode having high lithium ion conductivity. Furthermore, since the electrode includes the ionic liquid containing the lithium salt dissolved, the ionic liquid can infiltrate interparticle voids, for example, between particles of the active material, particles of the solid electrolyte, and the active material and the solid electrolyte in the electrode and voids in secondary particles of the active material and the solid electrolyte, thereby enhancing the ion conductivity (i.e., the effective ion conductivity) of the electrode as a whole. Therefore, the battery according to Embodiment 1, which is a battery including a halide solid electrolyte, can increase the discharge voltage and the active material utilization rate. That is, the battery according to Embodiment 1 having the above configuration can provide a new all-solid-state battery excellent in battery properties.

In the electrode including the ionic liquid containing the lithium salt dissolved, the volume proportion of the ionic liquid may be less than 15 vol. %.

In the electrode including the ionic liquid containing the lithium salt dissolved, the volume proportion of the ionic liquid may be, for example, 0.01 vol. % or more.

For example, the positive electrode may include the solid electrolyte including Li, M, and X, namely a halogen compound solid electrolyte, and the ionic liquid containing the lithium salt dissolved. When the positive electrode includes the ionic liquid containing the lithium salt dissolved, the active material utilization rate is further increased.

For example, only the positive electrode may include the ionic liquid containing the lithium salt dissolved. That is, the negative electrode does not necessarily include the ionic liquid as long as the positive electrode does.

Both the positive electrode and the negative electrode may include the above solid electrolyte, namely a halogen compound solid electrolyte, and the ionic liquid containing the lithium salt dissolved.

A lithium ion conductivity at 25° C. may be 1.0×10⁻⁵ S/cm or more in a composite of the ionic liquid and the solid electrolyte. When the composite of the ionic liquid containing the lithium salt dissolved and the solid electrolyte has such a lithium ion conductivity, the electrode according to Embodiment 1 can further increase the discharge voltage and the active material utilization rate.

When the composite of the ionic liquid containing the lithium salt dissolved and the solid electrolyte has the above lithium ion conductivity, the electrode according to Embodiment 1 can further increase the discharge voltage and the active material utilization rate.

In the battery according to Embodiment 1, the lithium salt to be dissolved in the ionic liquid may include at least one selected from the group consisting of lithium tetrafluoroborate (LiBF₄), lithium hexafluorophosphate (LiPF₆), lithium perchlorate (LiClO₄), lithium trifluoromethanesulfonate (CF₃SO₃Li), lithium bis(trifluoromethanesulfonyl)imide (LiN(SO₂CF₃)₂), lithium bis(fluorosulfonyl)imide (LiN(SO₂F)₂), and lithium bis(pentafluoroethanesulfonyl)imide (LiN(SO₂C₂F₅)₂).

By using the above compound(s) as the lithium salt to be dissolved in the ionic liquid, the electrode according to Embodiment 1 can further increase the discharge voltage and the active material utilization rate.

Examples of the cation included in the ionic liquid include:
(i) aliphatic chain quaternary salts such as tetraalkylammonium and tetraalkylphosphonium;
(ii) aliphatic cyclic ammoniums such as pyrrolidiniums, morpholiniums, imidazoliniums, tetrahydropyrimidiniums, piperaziniums, and piperidiniums; and
(iii) nitrogen-containing heterocyclic aromatic cations such as pyridiniums and imidazoliums.

Examples of the anion included in the ionic liquid include PF₆⁻, BF₄⁻, SbF₆⁻, AsF₆⁻, CH₃SO₄⁻, CF₃SO₃⁻, N(NC)₂⁻, N(SO₂CF₃)₂⁻, N(SO₂C₂F₅)₂⁻, N(FSO₂)₂⁻, N(SO₂CF₃)(SO₂C₄F₉)⁻, and C(SO₂CF₃)₃⁻.

In the battery according to Embodiment 1, for example, the solubility of the lithium salt in the ionic liquid used is high. The ionic liquid for the positive electrode is desirably, for example, an ionic liquid in which the solubility of the lithium salt is high and that has a noble redox potential. The ionic liquid for the negative electrode is desirably, for example, an ionic liquid in which the solubility of the lithium salt is high and that has a base redox potential.

In the battery according to Embodiment 1, the ionic liquid may include: at least one cation selected from the group consisting of an ammonium-based cation, an imidazolium-based cation, a piperidinium-based cation, a pyridinium-based cation, and a pyrrolidinium-based cation; and at least one anion selected from the group consisting of BF₄⁻, N(NC)₂⁻, N(SO₂CF₃)₂⁻, N(FSO₂)₂⁻, CH₃SO₄⁻, CF₃SO₃⁻, and PF₆⁻.

When the ionic liquid includes the above cation(s) and the above anion(s), the electrode according to Embodiment 1 can further increase the discharge voltage and the active material utilization rate.

The battery according to Embodiment 1 may be an all-solid-state battery. The all-solid-state battery may be a primary battery or a secondary battery.

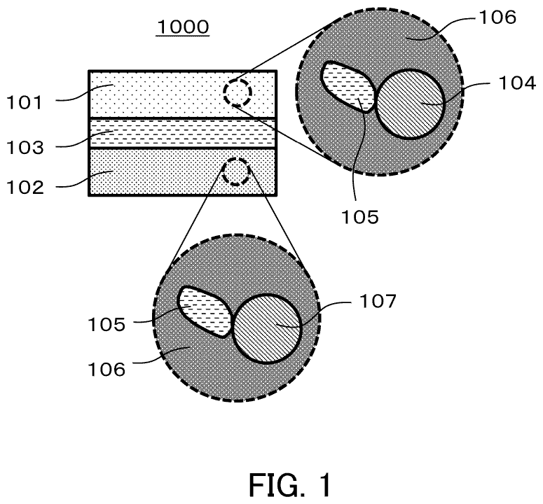

FIG. 1 is a cross-sectional view showing a battery 1000 according to the embodiment of the present disclosure.

The battery 1000 according to the present embodiment includes a positive electrode 101, a negative electrode 102, and an electrolyte layer 103 disposed between the positive electrode 101 and the negative electrode 102.

The positive electrode 101 includes a positive electrode active material 104, a solid electrolyte 105 including Li, M, and X, and an ionic liquid 106 containing a lithium salt dissolved.

The negative electrode 102 includes a negative electrode active material 107, the solid electrolyte 105 including Li, M, and X, and the ionic liquid 106 containing the lithium salt dissolved.

In the battery 1000 shown in FIG. 1, both the positive electrode 101 and the negative electrode 102 include the solid electrolyte 105 including Li, M, and X and the ionic liquid 106 containing the lithium salt dissolved. However, as described above, at least one selected from the group consisting of the positive electrode 101 and the negative electrode 102 is required to include the solid electrolyte 105 and the ionic liquid 106 containing the lithium salt dissolved.

Each constituent of the battery 1000 according to Embodiment 1 will be described hereinafter in more details.

### [Positive Electrode 101]

As described above, the positive electrode 101 includes the positive electrode active material 104, the solid electrolyte 105 including Li, M, and X, and the ionic liquid 106 containing the lithium salt dissolved.

The positive electrode 101 includes a material having properties of occluding and releasing metal ions as the positive electrode active material. The metal ions are typically lithium ions.

In the positive electrode 101, the positive electrode active material 104 and the solid electrolyte 105 may be in contact with each other. The positive electrode 101 may include a plurality of particles of the positive electrode active material 104 and a plurality of particles of the solid electrolyte 105. The ionic liquid 106 may be in contact with each of the positive electrode active material 104 and the solid electrolyte 105.

Examples of the positive electrode active material 104 include a lithium-containing transition metal oxide, a transition metal fluoride, a polyanion material, a fluorinated polyanion material, a transition metal sulfide, a transition metal oxysulfide, and a transition metal oxynitride. Examples of the lithium-containing transition metal oxide include Li(Ni,Co,Al)O₂, Li(Ni,Co,Mn)O₂, and LiCoO₂.

In the present disclosure, an expression, for example, “(Ni,Co,Al)” in a formula refers to at least one element selected from the group of elements in the parentheses. In other words, “(Ni,Co,Al)” is synonymous with the expression “at least one selected from the group consisting of Ni, Co, and Al”. The same applies to other elements.

The positive electrode active material 104 may have a median diameter of 0.1 μm or more and 100 μm or less. When the positive electrode active material 104 has a median diameter of 0.1 μm or more, the positive electrode active material 104 and the solid electrolyte 105 are in a favorable dispersion state in the positive electrode 101. That enhances the charge and discharge characteristics of the battery 1000. When the positive electrode active material 104 has a median diameter of 100 μm or less, the lithium diffusion rate in the positive electrode active material 104 is increased. Therefore, the battery 1000 can operate at high power.

The median diameter of the positive electrode active material 104 may be larger than that of the solid electrolyte 105. In this case, the positive electrode active material 104 and the solid electrolyte 105 are in a favorable dispersion state in the positive electrode 101.

Herein, the median diameter means a particle size (volume average particle size) at cumulative volume of 50% in a volume-based particle size distribution measured by laser diffraction-scattering.

In the positive electrode 101, a ratio of a volume of the positive electrode active material 104 to the sum of the volume of the positive electrode active material 104 and that of the solid electrolyte 105 may be 0.30 or more and 0.95 or less. In this case, the energy density and the output of the battery 1000 increase.

A coating layer may be formed on at least a portion of the surface of the positive electrode active material 104. The coating layer can be formed on the surface of the positive electrode active material 104, for example, before the conductive additive and a binder are mixed. A coating material included in the coating layer is, for example, a sulfide solid electrolyte, an oxide solid electrolyte, or a halide solid electrolyte. An increase of an overvoltage of the battery 1000 can be suppressed by suppressing oxidative decomposition of the solid electrolyte material by means of the coating layer of the positive electrode active material 104.

The positive electrode 101 may have a thickness of 10 μm or more and 500 μm or less. In this case, the energy density and the output of a battery including this positive electrode increase.

The solid electrolyte 105 is a solid electrolyte having metal ion conductivity. The metal ions are typically lithium ions. The solid electrolyte 105 includes, as described above, Li, M, and X. That is, the solid electrolyte 105 includes a halide solid electrolyte.

To increase the ion conductivity, M may include at least one selected from the group consisting of Mg, Ca, Sr, Ba, Zn, Sc, Al, Ga, Bi, Zr, Hf, Ti, Sn, Ta, and Nb.

To further increase the ion conductivity, M may include at least one selected from the group consisting of Mg, Ca, Sr, Y, Sm, Gd, Dy, and Hf.

To further increase the ion conductivity, M may include Y.

To increase the ion conductivity, X may include at least one selected from the group consisting of Br and I.

Examples of the halide solid electrolyte included in the solid electrolyte 105 include Li₂MgX₄, Li₂FeX₄, Li(Al,Ga,In)X₄, Li₃(Al,Ga,In)X₆, and LiI.

Another example of the halide solid electrolyte is a compound represented by LiₐMe_{b}Y_{c}X₆. Here, a+mb+3c=6 and c>0 are satisfied. The symbol Me is at least one element selected from the group consisting of metalloid elements and metal elements other than Li and Y The symbol m represents the valence of Me.

To increase the ion conductivity of the halide solid electrolyte, Me may be at least one selected from the group consisting of Mg, Ca, Sr, Ba, Zn, Sc, Al, Ga, Bi, Zr, Hf, Ti, Sn, Ta, and Nb.

The halide solid electrolyte may be Li₃YCl₆ or Li₃YBr₆.

The solid electrolyte 105 may substantially consist of Li, M, and X. Saying that “the solid electrolyte 105 substantially consists of Li, M, and X” means that a ratio (namely, a molar fraction) of the total amount of substance of Li, M, and X to the total amount of substance of all elements in the solid electrolyte 105 is 90% or more in the solid electrolyte 105. In one example, the ratio (namely, the molar fraction) may be 95% or more. The solid electrolyte 105 may consist only of Li, M, and X.

The solid electrolyte 105 may further include at least one selected from the group consisting of O, S, and F in addition to Li, M, and X. For example, in addition to the halide solid electrolyte including Li, M, and X, the solid electrolyte 105 may include an additional solid electrolyte that is not a halide solid electrolyte. The additional solid electrolyte may be at least one selected from the group consisting of an oxide solid electrolyte, a sulfide solid electrolyte, and a polymer solid electrolyte. The solid electrolyte 105 may include the halide solid electrolyte including Li, M, and X as its main component. Saying that “the solid electrolyte 105 includes the halide solid electrolyte including Li, M, and X as its main component” means that the halide solid electrolyte including Li, M, and X is largest in the solid electrolyte 105 in terms of amount of substance.

Examples of the sulfide solid electrolyte include Li₂S—P₂S₅, Li₂S—SiS₂, Li₂S—B₂S₃, Li₂S—GeS₂, Li_{3.25}Ge_{0.25}P_{0.75}S₄, Li₁₀GeP₂S₁₂, and Li₆PS₅Cl. Moreover, LiX, Li₂O, MO_{q}, LiₚMO_{q}, or the like may be added thereto. Here, X is at least one element selected from the group consisting of F, Cl, Br, and I. The symbol M is at least one element selected from the group consisting of P, Si, Ge, B, Al, Ga, In, Fe, and Zn. The symbols p and q are each independently a natural number. One sulfide solid electrolyte selected from the above materials or two or more of sulfide solid electrolytes selected from the above materials can be used.

The oxide solid electrolyte can be, for example: a NASICON solid electrolyte typified by LiTi₂(PO₄)₃ and element-substituted substances thereof; a (LaLi)TiO₃-based perovskite solid electrolyte; a LISICON solid electrolyte typified by Li₁₄ZnGe₄O₁₆, Li₄SiO₄, LiGeO₄ and element-substituted substances thereof; a garnet solid electrolyte typified by Li₇La₃Zr₂O₁₂ and element-substituted substances thereof; Li₃PO₄ and N-substituted substances thereof; or a glass or glass ceramic that includes a Li—B—O compound, such as LiBO₂ or Li₃BO₃, as a base and to which Li₂SO₄, Li₂CO₃, or the like is added. One oxide solid electrolyte selected from the above materials or two or more of oxide solid electrolytes selected from the above materials can be used.

For example, a compound of a polymer compound and a lithium salt can be used as the polymer solid electrolyte. The polymer compound may have an ethylene oxide structure. The polymer compound having an ethylene oxide structure can contain a large amount of the lithium salt. Therefore, the ionic conductivity can further be enhanced. The lithium salt can be LiPF₆, LiBF₄, LiSbF₆, LiAsF₆, LiSO₃CF₃, LiN(SO₂CF₃)₂, LiN(SO₂C₂F₅)₂, LiN(SO₂CF₃)(SO₂C₄F₉), LiC(SO₂CF₃)₃, or the like. One lithium salt selected from the examples of the lithium salt can be used alone. Alternatively, a mixture of two or more lithium salts selected from the examples of the lithium salt can be used.

The positive electrode 101 includes the ionic liquid 106 containing the lithium salt dissolved. In Embodiment 1, the ionic liquid included in the electrode and containing the lithium salt dissolved is as described above.

The positive electrode 101 may further include a non-aqueous electrolyte solution or a gel electrolyte in order to facilitate exchange of metal ions (e.g., lithium ions) and enhance the output properties of the battery.

The non-aqueous electrolyte solution contains a non-aqueous solvent and a lithium salt dissolved in the non-aqueous solvent.

Examples of the non-aqueous solvent include a cyclic carbonate solvent, a chain carbonate solvent, a cyclic ether solvent, a chain ether solvent, a cyclic ester solvent, a chain ester solvent, and a fluorinated solvent. Examples of the cyclic carbonate solvent include ethylene carbonate, propylene carbonate, and butylene carbonate. Examples of the chain carbonate solvent include dimethyl carbonate, ethyl methyl carbonate, and diethyl carbonate. Examples of the cyclic ether solvent include tetrahydrofuran, 1,4-dioxane, and 1,3-dioxolane. Examples of the chain ether solvent include 1,2-dimethoxyethane and 1,2-diethoxyethane. Examples of the cyclic ester solvent include γ-butyrolactone. Examples of the chain ester solvent include methyl acetate. Examples of the fluorinated solvent include fluoroethylene carbonate, methyl fluoropropionate, fluorobenzene, fluoroethyl methyl carbonate, and fluorodimethylene carbonate.

One non-aqueous solvent selected from these may be used alone. Alternatively, a mixture of two or more non-aqueous solvents selected from these may be used.

Examples of the lithium salt included in the non-aqueous electrolyte solution include LiPF₆, LiBF₄, LiSbF₆, LiAsF₆, LiSO₃CF₃, LiN(SO₂CF₃)₂, LiN(SO₂C₂F₅)₂, LiN(SO₂CF₃)(SO₂C₄F₉), and LiC(SO₂CF₃)₃. One lithium salt selected from these may be used alone. Alternatively, a mixture of two or more lithium salts selected from these may be used.

The concentration of the lithium salt in the non-aqueous electrolyte solution is, for example, 0.5 mol/L or more and 2 mol/L or less.

A polymer material impregnated with the non-aqueous electrolyte solution can be used as the gel electrolyte. Examples of the polymer material include polyethylene oxide, polyacrylonitrile, polyvinylidene fluoride, polymethylmethacrylate, and a polymer having an ethylene oxide bond.

The positive electrode 101 may include a binder so as to improve the adhesion between the particles.

Examples of the binder include polyvinylidene fluoride, polytetrafluoroethylene, polyethylene, polypropylene, aramid resin, polyamide, polyimide, polyamide-imide, polyacrylonitrile, polyacrylic acid, polyacrylic acid methyl ester, polyacrylic acid ethyl ester, polyacrylic acid hexyl ester, polymethacrylic acid, polymethacrylic acid methyl ester, polymethacrylic acid ethyl ester, polymethacrylic acid hexyl ester, polyvinyl acetate, polyvinylpyrrolidone, polyether, polyethersulfone, hexafluoropolypropylene, styrene-butadiene rubber, and carboxymethyl cellulose. A copolymer can also be used as the binder. Such a binder is, for example, a copolymer of two or more materials selected from the group consisting of tetrafluoroethylene, hexafluoroethylene, hexafluoropropylene, perfluoroalkyl vinyl ether, vinylidene fluoride, chlorotrifluoroethylene, ethylene, propylene, pentafluoropropylene, fluoromethyl vinyl ether, acrylic acid, and hexadiene. A mixture of two or more materials selected from the above materials may also be used as the binder.

The positive electrode 101 may include a conductive additive to decrease an electron resistance.

The conductive additive can be, for example: graphite, such as natural graphite or artificial graphite; carbon black, such as acetylene black or Ketjenblack; a conductive fiber, such as a carbon fiber or a metal fiber; carbon fluoride; a metal powder, such as aluminum powder; a conductive whisker, such as a zinc oxide whisker or a potassium titanate whisker; a conductive metal oxide, such as titanium oxide; or a conductive polymer compound, such as polyaniline, polypyrrole, or polythiophene. Using a conductive carbon additive as the conductive additive can seek cost reduction.

### [Negative Electrode 102]

As described above, the negative electrode 102 includes the negative electrode active material 107, the solid electrolyte 105 including Li, M, and X, and the ionic liquid 106 containing the lithium salt dissolved.

The negative electrode 102 includes a material having properties of occluding and releasing metal ions as the negative electrode active material 107. The metal ions are typically lithium ions.

In the negative electrode 102, the negative electrode active material 107 and the solid electrolyte 105 may be in contact with each other. The negative electrode 102 may include a plurality of particles of the negative electrode active material 107 and a plurality of particles of the solid electrolyte 105. The ionic liquid 106 may be in contact with each of the negative electrode active material 107 and the solid electrolyte 105.

Examples of the negative electrode active material 107 include a metal material, a carbon material, an oxide, a nitride, a tin compound, and a silicon compound. The metal material may be a simple substance of a metal or may be an alloy. Examples of the metal material include lithium metal and a lithium alloy. Examples of the carbon material include natural graphite, coke, semi-graphitized carbon, a carbon fiber, spherical carbon, artificial graphite, and amorphous carbon. In terms of the capacity density, the negative electrode active material is suitably, for example, silicon (namely, Si), tin (namely, Sn), a silicon compound, or a tin compound.

The negative electrode active material 107 may be selected taking account of the reduction resistance of the solid electrolyte 105 included in the negative electrode 102. For example, when the negative electrode 102 includes a solid electrolyte material consisting of a halide as the solid electrolyte 105, the negative electrode active material 107 may be a material having properties of occluding and releasing lithium ions at 0.27 V or more versus lithium. Examples of such a negative electrode active material 107 include a titanium oxide, indium metal, and a lithium alloy. Examples of the titanium oxide include Li₄Ti₅O₁₂, LiTi₂O₄, and TiO₂. Reductive decomposition of the solid electrolyte 105 included in the negative electrode 102 can be suppressed by using such a negative electrode active material 107. Consequently, the charge and discharge characteristics of the battery 1000 can be enhanced.

The negative electrode active material 107 may have a median diameter of 0.1 μm or more and 100 μm or less. When the negative electrode active material 107 has a median diameter of 0.1 μm or more, the negative electrode active material 107 and the solid electrolyte 105 are in a favorable dispersion state in the negative electrode 102. That enhances the charge and discharge characteristics of the battery 1000. When the negative electrode active material 107 has a median diameter of 100 μm or less, the lithium diffusion rate in the negative electrode active material 107 is increased. Therefore, the battery 1000 can operate at high power.

The median diameter of the negative electrode active material 107 may be larger than that of the solid electrolyte 105. In this case, the negative electrode active material 107 and the solid electrolyte 105 are in a favorable dispersion state in the negative electrode 102.

In the negative electrode 102, a ratio of a volume of the negative electrode active material 107 to the sum of the volume of the negative electrode active material 107 and that of the solid electrolyte 105 may be 0.30 or more and 0.95 or less. In this case, the energy density and the output of the battery 1000 increase.

Descriptions of the solid electrolyte 105 in the negative electrode 102 and the halide solid electrolyte included in the solid electrolyte 105 and including Li, M, and X are the same as the descriptions of the solid electrolyte 105 and the halide solid electrolyte in the positive electrode 101. Therefore, descriptions of the solid electrolyte 105 and the halide solid electrolyte in the negative electrode 102 are omitted here. Additionally, the solid electrolyte 105 in the negative electrode 102 may further include an additional solid electrolyte that is not a halide solid electrolyte, as does the positive electrode 101. Examples of the solid electrolyte are as described for the positive electrode 101.

The negative electrode 102 includes the ionic liquid 106 containing the lithium salt dissolved. In Embodiment 1, the ionic liquid included in the electrode and containing the lithium salt dissolved is as described above.

The negative electrode 102 may further include a non-aqueous electrolyte solution or a gel electrolyte in order to facilitate exchange of metal ions (e.g., lithium ions) and enhance the output properties of the battery, as does the positive electrode 101. Examples of the non-aqueous electrolyte solution and the gel electrolyte are as described for the positive electrode 101.

The negative electrode 102 may include a binder so as to improve the adhesion between the particles, as does the positive electrode 101. Examples of the binder are as described for the positive electrode 101.

The negative electrode 102 may include a conductive additive to decrease an electron resistance, as does the positive electrode 101. Examples of the conductive additive are as described for the positive electrode 101.

### [Electrolyte Layer 103]

The electrolyte layer 103 includes a solid electrolyte. Examples of the solid electrolyte included in the electrolyte layer 103 include a sulfide solid electrolyte, an oxide solid electrolyte, and a halide solid electrolyte. The sulfide solid electrolyte, the oxide solid electrolyte, and the halide solid electrolyte that can be included in the electrolyte layer 103 are respectively the same as the sulfide solid electrolyte, the oxide solid electrolyte, and the halide solid electrolyte that can be included in the solid electrolyte 105 of the positive electrode 101. Therefore, detailed descriptions of the sulfide solid electrolyte, the oxide solid electrolyte, and the halide solid electrolyte that can be included in the electrolyte layer 103 are omitted here.

The electrolyte layer 103 may have a thickness of 1 μm or more and 1000 μm or less. In this case, the energy density and the output of the battery 1000 increase.

The electrolyte layer 103 may include a non-aqueous electrolyte solution, a gel electrolyte, or an ionic liquid in order to facilitate exchange of metal ions (e.g., lithium ions) and enhance the output properties of the battery 1000. The non-aqueous electrolyte solution, the gel electrolyte, and the ionic liquid included in the electrolyte layer 103 are respectively the same as the non-aqueous electrolyte solution, the gel electrolyte, and the ionic liquid described for the positive electrode 101 and the negative electrode 102. Therefore, detailed descriptions of the non-aqueous electrolyte solution, the gel electrolyte, and the ionic liquid that can be included in the electrolyte layer 103 are omitted here.

The electrolyte layer 103 may include a binder so as to improve the adhesion between the particles. The binder included in the electrolyte layer 103 is the same as the binder described for the positive electrode 101 and the negative electrode 102. Therefore, a detailed description of the binder that can be included in the electrolyte layer 103 is omitted here.

The positive electrode 101, the negative electrode 102, and the electrolyte layer 103 may include different solid electrolytes from each other for increasing the ion conductivity, the chemical stability, and the electrochemical stability.

The shape of the battery 1000 according to Embodiment 1 is, for example, a coin type, a cylindrical type, a prismatic type, a sheet type, a button type, a flat type, or a stack type.

### <Battery Manufacturing Method>

The battery 1000 according to Embodiment 1 may be manufactured, for example, by preparing materials for formation of the positive electrode, the electrolyte layer, and the negative electrode and then producing by a known method a multilayer body in which the positive electrode 101, the electrolyte layer 103, and the negative electrode 102 are disposed in this order.

### Embodiment 2

Embodiment 2 will be hereinafter described. A description overlapping with that of Embodiment 1 is omitted as appropriate.

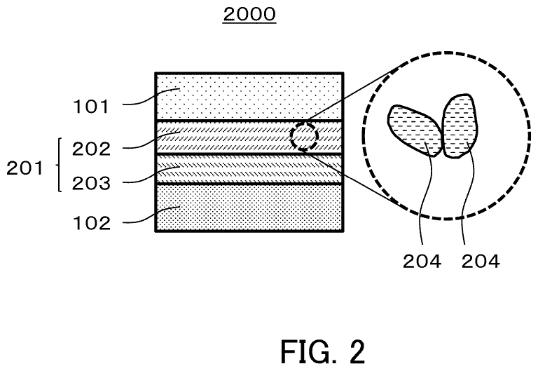

FIG. 2 is a cross-sectional view schematically showing a configuration of a battery 2000 according to Embodiment 2.

The battery 2000 includes the positive electrode 101, the negative electrode 102, and an electrolyte layer 201. The electrolyte layer 201 is disposed between the positive electrode 101 and the negative electrode 102. The electrolyte layer 201 includes a first electrolyte layer 202 and a second electrolyte layer 203. The first electrolyte layer 202 is disposed between the positive electrode 101 and the negative electrode 102. The second electrolyte layer 203 is disposed between the first electrolyte layer 202 and the negative electrode 102. The first electrolyte layer 202 includes a solid electrolyte 204.

When a solid electrolyte material having high oxidation resistance is used as the solid electrolyte 204, oxidation of a solid electrolyte included in the second electrolyte layer 203 can be suppressed owing to the first electrolyte layer 202. Consequently, the battery 2000 can have further enhanced charge and discharge characteristics.

The first electrolyte layer 202 may include a plurality of particles of the solid electrolyte 204. In the first electrolyte layer 202, the plurality of particles of the solid electrolyte 204 may be in contact with each other.

In the battery 2000, the solid electrolyte included in the second electrolyte layer 203 may have a reduction potential lower than that of the solid electrolyte 204 included in the first electrolyte layer 202. In this case, reduction of the solid electrolyte 204 included in the first electrolyte layer 202 can be suppressed. Consequently, the battery 2000 can have enhanced charge and discharge characteristics. For example, when the first electrolyte layer 202 includes a halide solid electrolyte as the solid electrolyte 204, the second electrolyte layer 203 may include a sulfide solid electrolyte to suppress reduction decomposition of the halide solid electrolyte.

### EXAMPLES

Hereinafter, details of the present disclosure will be described with reference to an example and a comparative example.

### Example 1

### [Preparation of Ionic Liquid Containing Lithium Salt Dissolved]

Lithium bis(trifluoromethanesulfonyl)imide (LiN(SO₂CF₃)₂) and 1-butyl-3-methylimidazolium (trifluoromethanesulfonyl)imide (CH₃C₃H₃N₂C₄H₉[N(SO₂CF₃)₂]) were weighed so that the lithium salt concentration would be 0.5 mol/L. That is, LiN(SO₂CF₃)₂ was used as a lithium salt, and CH₃C₃H₃N₂C₄H₉[N(SO₂CF₃)₂] was used as an ionic liquid. These were mixed and stirred to obtain an ionic liquid according to Example 1 containing a lithium salt dissolved.

### [Production of Battery]

In an argon atmosphere, LiNi_{0.6}Co_{0.2}Mn_{0.2}O₂ being a positive electrode active material of Example 1 and Li₃YCl₆ being a solid electrolyte of Example 1 were prepared at a volume ratio of LiNi_{0.6}Co_{0.2}Mn_{0.2}O₂:Li₃YCl₆=45:55. The ionic liquid according to Example 1 containing a lithium salt dissolved and prepared in the above manner was added in an amount of 0.13 mass %, and then an organic polymer being a binder was added in an amount of 0.87 mass %. The resulting material was dispersed in para-chlorotoluene. The resulting dispersion was applied to a thickness of 60 μm. A positive-electrode-applied electrode was obtained in this manner. It should be noted that the ionic liquid was the only liquid component included in the positive-electrode-applied electrode; the para-chlorotoluene had volatilized and did not remain in the positive-electrode-applied electrode. In the positive-electrode-applied electrode, the volume proportion of the ionic liquid containing a lithium salt dissolved was 0.09 vol. %. Additionally, in a composite of the ionic liquid containing a lithium salt dissolved and the solid electrolyte Li₃YCl₆ mixed at the above volume ratio, the lithium ion conductivity at 25° C. was 1.06×10⁻⁴ S/cm. The method for measuring the lithium ion conductivity of the composite of the ionic liquid containing a lithium salt dissolved and the solid electrolyte will be described later.

In an argon atmosphere, the positive-electrode-applied electrode, Li₃YCl₆ (40 mg) as a first electrolyte layer, Li₆PS₅Cl (80 mg) as a second electrolyte layer, and indium and Li metals as a negative electrode were layered in this order in an insulating cylinder having an inner diameter of 9.5 mm. A 300 MPa pressure was applied to the resulting multilayer body. A positive electrode, an electrolyte layer, and a negative electrode were formed in this manner.

Next, current collectors made of stainless steel were attached to the positive electrode and the negative electrode, and a current collector lead was attached to each of the current collectors.

Finally, an insulating ferrule was used to isolate the inside of the insulating cylinder from the outside atmosphere and hermetically seal the cylinder. A battery according to Example 1 was obtained in this manner.

### Comparative Example

### [Production of Battery]

No ionic liquid containing a lithium salt dissolved was added to the materials for production of a positive-electrode-applied electrode. Except for this, a battery according to Comparative Example was produced in the same manner as in Example.

### (Ion Conductivity Measuring Method)

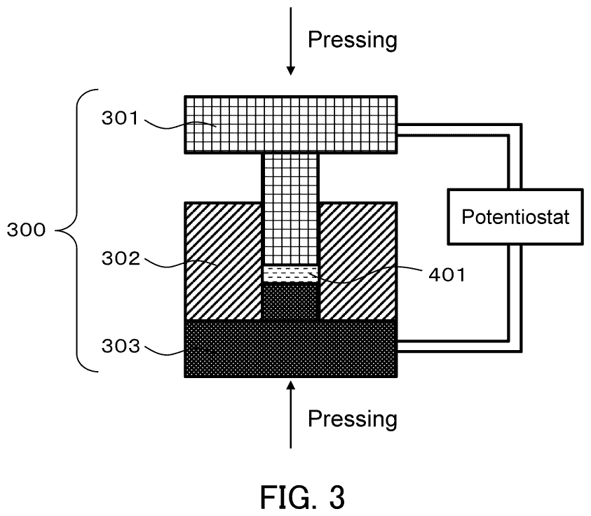

FIG. 3 is a schematic diagram showing a compression molding die 300 used for evaluation of the ionic conductivity of the composite of the ionic liquid containing a lithium salt dissolved and the solid electrolyte.

The compression molding die 300 includes an upper punch 301, a die 302, and a lower punch 303. The die 302 was made of polycarbonate, which has insulating properties. Both the upper punch 301 and the lower punch 303 were made of stainless steel, which is electron conductive.

The ion conductivity of a composite of the ionic liquid containing a lithium salt dissolved and the solid electrolyte was measured by the following method using the compression molding die 300 as shown in FIG. 3, the composite (hereinafter referred to as “composite of Example 1”) being produced in Example 1.

In a dry atmosphere having a dew point of −30° C. or lower, the composite of Example 1 was charged as a measurement specimen 401 into the compression molding die 300. A 400 MPa pressure was applied to the composite of Example 1 in the compression molding die 300 using the upper punch 301.

While the pressure was being applied, the upper punch 301 and the lower punch 303 were connected to a potentiostat (VMP-300 manufactured by Bio-Logic Sciences Instruments) equipped with a frequency response analyzer. The upper punch 301 was connected to a working electrode and a potential measuring terminal. The lower punch 303 was connected to a counter electrode and a reference electrode. The ion conductivity of the composite of Example 1 was measured at room temperature by an electrochemical impedance measurement method.

### (Charge-Discharge Test)

Each of the batteries of Example and Comparative Example was connected to a potentiostat (VSP-300 manufactured by BioLogic) equipped with a frequency response analyzer. The positive electrode current collector was connected to a working electrode and a potential measuring terminal. The negative electrode current collector was connected to a counter electrode and a reference electrode. The charge-discharge test was carried out in a constant-temperature chamber (25° C.).

First, the battery was placed in a constant-temperature chamber at 25° C., and was then charged at a current density corresponding to 0.05 C rate with respect to a theoretical capacity of the battery until the positive electrode reached a voltage of 3.68 V relative to the negative electrode.

Next, the battery was discharged at a current density corresponding to 0.05 C rate with respect to the theoretical capacity of the battery until the positive electrode reached a voltage of 1.88 V relative to the negative electrode.

Table 1 shows the active material utilization rate, the discharge capacity, and the mean discharge voltage each calculated from the results of the above charge-discharge test. The fill rate shown in Table 1 is a proportion of a volume of a material mixture estimated from the density of the material mixture and the mass of the positive electrode in an actual volume of the positive electrode, the material mixture being composed of the active material, the solid electrolyte, the ionic liquid, and the binder. The active material utilization rate is a ratio of the capacity of the battery to the actual capacity of the active material. The term “mean discharge voltage” refers to a voltage at a point where the total discharged energy (i.e., a cumulative value of products of discharge voltage and electric capacitance) becomes ½.

TABLE 1

| | Addition of | | | | |
|---|---|---|---|---|---|
| | ionic liquid | | | | Active |
| | containing | Fill | Discharge | Mean | material |
| | lithium salt | rate | capacity | discharge | utilization |
| | dissolved | (%) | (mAh/g) | voltage (V) | rate (%) |
| Example | Added | 93.8 | 189.0 | 3.80 | 94.5 |
| Comparative | Not added | 89.8 | 185.3 | 3.79 | 92.6 |
| Example | | | | | |

### Discussion

As is obvious from the results for Example and Comparative Example, increases of all of the discharge capacity, the mean discharge voltage, and the active material utilization rate have been confirmed for the battery produced by adding the ionic liquid containing a lithium salt dissolved to produce the positive electrode. This is presumably because the effective ion conductivity increasing effect of the positive electrode produced using the materials including the ionic liquid containing a lithium salt dissolved was exhibited.

Similar effects can be achieved by using lithium salts other than LiN(SO₂CF₃)₂ and ionic liquids other than CH₃C₃H₃N₂C₄H₉[N(SO₂CF₃)₂]. This is because it is inferred that a similar effect can be exhibited by charging voids in an electrode with a liquid material having lithium ion conductivity.

As shown in the above Example, the present disclosure can provide a new battery having an increased active material utilization rate and an increased discharge voltage.

### INDUSTRIAL APPLICABILITY

The battery of the present disclosure can be used, for example, as an all-solid-state lithium-ion secondary battery.

What is claimed is:

1. A battery comprising:
a positive electrode;
a negative electrode; and
an electrolyte layer disposed between the positive electrode and the negative electrode, wherein
at least one electrode selected from the group consisting of the positive electrode and the negative electrode includes a solid electrolyte and an ionic liquid containing a lithium salt dissolved,
in the electrode including the ionic liquid containing the lithium salt dissolved, a volume proportion of the ionic liquid is less than 20 vol. %,
the solid electrolyte includes Li, M, and X,
the M is at least one selected from the group consisting of metalloid elements and metal elements except Li, and
the X is at least one selected from the group consisting of F, Cl, Br, and I.

2. The battery according to claim 1, wherein the positive electrode is the electrode including the solid electrolyte and the ionic liquid.

3. The battery according to claim 1, wherein a lithium ion conductivity at 25° C. is 1.0×10⁻⁵ S/cm or more in a composite of the ionic liquid and the solid electrolyte.

4. The battery according to claim 1, wherein the lithium salt includes at least one selected from the group consisting of lithium tetrafluoroborate (LiBF₄), lithium hexafluorophosphate (LiPF₆), lithium perchlorate (LiClO₄), lithium trifluoromethanesulfonate (CF₃SO₃Li), lithium bis(trifluoromethanesulfonyl)imide (LiN(SO₂CF₃)₂), lithium bis(fluorosulfonyl)imide (LiN(SO₂F)₂), and lithium bis(pentafluoroethanesulfonyl)imide (LiN(SO₂C₂F₅)₂).

5. The battery according to claim 1, wherein the ionic liquid includes: at least one cation selected from the group consisting of an ammonium-based cation, an imidazolium-based cation, a piperidinium-based cation, a pyridinium-based cation, and a pyrrolidinium-based cation; and at least one anion selected from the group consisting of BF₄⁻, N(NC)₂⁻, N(SO₂CF₃)₂⁻, N(FSO₂)₂⁻, CH₃SO₄⁻, CF₃SO₃⁻, and PF₆⁻.

6. The battery according to claim 1, wherein the M includes at least one selected from the group consisting of Mg, Ca, Sr, Y, Sm, Gd, Dy, and Hf.

7. The battery according to claim 1, wherein the X includes at least one selected from the group consisting of Br and I.

8. The battery according to claim 1, wherein the electrolyte layer includes a first electrolyte layer and a second electrolyte layer disposed between the first electrolyte layer and the negative electrode.
